(19) United States
(12) Patent Application Publication
(10) Pub. No.: US 2009/0083080 A1
(43) Pub. Date: Mar. 26, 2009

(54) Method, apparatus and program product for facilitating transfer of group meeting contracts

(76) Inventor: Tim Brooks, Chicago, IL (US)

Correspondence Address: VEDDER PRICE P.C., 222 N. LASALLE STREET, CHICAGO, IL, 60601, US

(21) Appl. No.: 11/860,273

(22) Filed: Sep. 24, 2007

(51) Int. Cl. G06Q 30/00; G06F 17/30; G06F 17/40

(52) U.S. Cl. 705/5

(57) ABSTRACT

A method for facilitating transfer of meeting contracts between parties includes providing a database of records of contracted meetings at hotels that are available for transfer. A search engine is provided for searching the contracted meeting records database according to entered criteria, the search engine operable to identify available contracted meeting records which meet the entered criteria. Access to the search engine is provided via a computer network. Upon execution of a given search including criteria entered by a searching user, the searching user is provided, via the computer network, with contracted meeting records information concerning at least one matching contracted meeting record which meets the entered criteria of the given search, if such a matching contracted meeting record exists.

### TECHNICAL FIELD

The present invention relates to a system and method for facilitating the transfer or assignment of group meeting contracts, wholly or in part, from a previously contracted group to a new group and, more particularly, a system and method for facilitating the transfer of hotel group meeting contracts via the Internet or other large-scale computer network.

### BACKGROUND OF THE INVENTION

For a variety of reasons persons or their organizations often choose to cancel or postpone a contracted meeting scheduled for a hall, convention center, hotel or the like for a future date. Many times such cancellations arise due to unforeseen circumstances, changes in business conditions, senior management scheduling changes, product launch delays, or a host of other reasons unrelated to generally understood force majeure cancellations. Force Majeure conditions are usually related to Acts of God, civil unrest, government regulation, Acts of War or Terrorism, curtailment of Transportation or other customary force majeure conditions. For example, cancellations of hotel or convention center contracts in force majeure circumstances are generally forgiven, or the insurance policies of the particular location and their group meeting contract customers often apply to these circumstances.

One problem associated with hotel and conference center meeting contracts is their dependence on the expectation of specific performance for contracted dates often occurring far in the future. In some situations a contracting group enters into a hotel or conference center group meeting contract several years in advance of group operation but later desires to get out of the contract terms prior to the dates of operation of the meeting. For example, such motivation to get out of a contract can be driven by a desire to obtain a different meeting venue due to changes in business conditions. Sometimes the contracting group wishes to cancel the meeting entirely.

Contracting groups sometimes want to postpone a meeting obligation to a later date. For the hotel or conference center that has entered into the contract, such postponements are as painful financially as outright cancellations, as they are usually unable to fully resell the highly perishable canceled or postponed dates, thereby incurring a loss of business that is costly or impossible to regain.

In most circumstances, the contracted meeting group responsible for cancellation has a contractual obligation to the contracted hotel or conference center to compensate the hotel or conference center for lost revenues or lost profits (“Cancellation Fee”). The amount of the cancellation fee is pre-determined by the contracting parties, is described in their contract, and is customarily variable over time, the cancellation fee increasing in value the nearer the cancellation occurs in time prior to the group's contracted dates.

Significant problems exist with obtaining payment of cancellation fees from the canceling party to the canceled hotel or conference center. Existing customs for collection of cancellation fees differ greatly from hotel to hotel and conference center to conference center and in the contracting customer community.

Generally, hotels find it very difficult to collect 100% of the fees due them from their canceling contracted customers. Litigation is a strategy frequently used by the parties in order to collect or mitigate all or part of the cancellation fees contractually owed.

Other remedies are also attempted, such as: group cannibalization (shifting another pre-existing contracted group to replace the canceled dates in order to make available the replacement group's more desirable dates for resale); partial credit for cancellation fees collected are applied by the canceled hotel to future anticipated group meeting contracts from the canceling customer; and distressed marketing and sales tactics applied by the canceled hotel, at significant expense to the canceled hotel, are used in an effort to resell any portion of the canceled room block and meeting space during operational dates of the canceled group meeting contract.

Often, the cancellation fees associated with terminating a contract prior to group operation are undesirably high for the canceling organization, but the cost obstacles and information hurdles associated with transferring the contract terms to another party may be substantial or insurmountable.

Even when cancellation fees are collected in total as contractually described, the canceled hotel or conference center still loses the significant ancillary discretionary revenue from individual guest spending that would normally be obtained or expected during the operational period of the canceled group.

With respect to hotels, canceling groups also lose substantial amounts of money with no hotel services received and have little or no prospect for recovery of advance deposits or cancellation fees already paid to a hotel unless the hotel is able to fully resell the exact contracted specifications (meeting space, group Food & Beverage functions, and guestrooms) vacated by the canceling party. A complete resale of vacated contracted dates rarely occurs due to impediments such as time constraints for contracting parties; lack of information about availability of previously contracted dates; and significant variance of contractual terms, contract formats, and cancellation valuation techniques used by different hotels.

Other impediments to transfers of contracted meetings exist, including a general lack of meeting planner information concerning the ability to transfer as well as liability issues raised for contracting parties who wish to transfer or assign their contracted terms.

Accordingly, it would be advantageous to hotels, conference centers and their group meeting customers to provide a system and method for facilitating the transfer of hotel meeting contracts between parties.

### SUMMARY OF THE INVENTION

In one aspect, the present invention is directed to a computer implemented method for facilitating the transfer of meeting contacts between partners. The method includes providing a database with stored available contracted meetings for transfer. The method further includes requested the selection of one or more available contracted meetings based on a requestors selected, arameter and displaying the selected contracted meeting. The method further includes the step of selecting one of the requested available contracted meetings for transfer and transferring the selected one of the requested available meeting from a contract term owner to a contract terms buyer. If a contact term owner wishes to, he may modify the terms of an available contracted meeting.

In still another aspect, a computer-based system for facilitating transfer of hotel meeting contracts between parties includes a web site computer system including a database of hotel group meeting contract records concerning hotel group meeting contracts available for transfer; and an Internet accessible search engine for searching the contracted meeting records database according to entered criteria, the search engine operable to identify available contracted meeting records which meet the entered criteria. The search engine is operable upon execution of a given search including criteria entered by a searching user, to produce a web page providing the searching user with access to at least certain contracted meeting records information concerning at least one matching contracted meeting record which meets the entered criteria of the given search, if such a matching contracted meeting record exists. The search engine is further operable upon input by the searching user to (i) store the entered criteria of the given search, (ii) associate the stored criteria with at least an e-mail of the searching user, (iii) conduct at least one future automated search of the contracted meeting records database for hotel group meeting contract records meeting the stored criteria, and (iv) initiate e-mail notification of the searching user in event the future automated search identifies at least one matching contracted meeting record. An Internet accessible contract terms action engine enables modifying the contracted meeting records database, the contract terms action engine producing at least one web page for the entry of information for a contracted meeting records record to be added to the contracted meeting records database by a listing user. The contract terms action engine is operable to associate an added contracted meeting record of the contracted meeting records database with the listing user upon addition of the added contracted meeting records record to the contracted meeting records database. The contract terms action engine is further operable to produce at least one web page for enabling a given user to delete or modify an existing contracted meeting records record of the contracted meeting records database only if the listing user associated with the existing contracted meeting records record is the given user.

### BRIEF DESCRIPTION OF THE DRAWINGS

The features of the present disclosure are believed to be novel and are set forth with particularity in the appended claims. The disclosure may best be understood by reference to the following description taken in conjunction with the accompanying drawings, and the figures that employ the reference numerals identify like elements.

FIG. 1 is a schematic web page flow chart showing one embodiment of a contract terms transfer system and method;

FIG. 2 is a schematic web page flow chart showing an aspect of the system and method of FIG. 1 in which a stored contracted meeting records record is modified or deleted; and

FIG. 3 is a schematic showing optional aspects of the system and method of FIG. 1, namely, connections between the Internet Website at which contracted meeting records are displayed and other sites where information concerning meeting planning and meeting guarantors are displayed.

FIG. 4 is a process chart for options from a home page of another embodiment of a hotel group meeting contract transfer system and method;

FIG. 5 illustrates a searching user/buyer transaction process;

FIG. 6 illustrates a listing user/seller ad placement process;

FIG. 7 illustrates a user account management process;

FIG. 8 illustrates a flow diagram of a contract terms transfer process;

FIG. 9 illustrates additional content options available from the web site;

FIG. 10 illustrates an exemplary display of hotel group meeting contract information; and

FIG. 11 illustrates an exemplary Internet supported system.

### DETAILED DESCRIPTION

The present invention is not limited to the particular details of the apparatus or method depicted, and other modifications and applications may be contemplated. Further changes may be made in the below-described method and apparatus without departing from the true spirit and the scope of the invention herein involved. It is intended, therefore, that the subject matter in the above depiction should be interpreted as illustrative, not in a limiting sense.

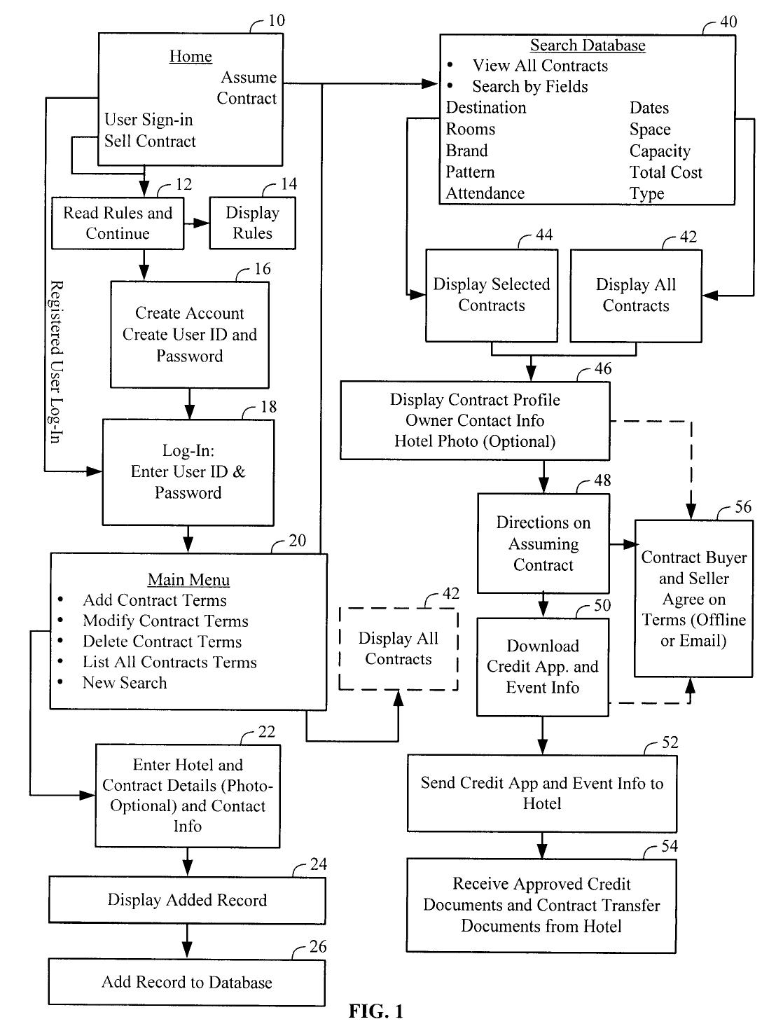

What is shown in FIGS. 1-11 is a new method, apparatus and system for facilitating the transfer of group hotel, meeting room, and conference center contracts between interested parties. It should be understood that the reference to contract meeting or contracted meeting means group hotel, meeting room, conference center contract and similar types of group contracts. For example, it could include group sales for sporting or entertainment events.

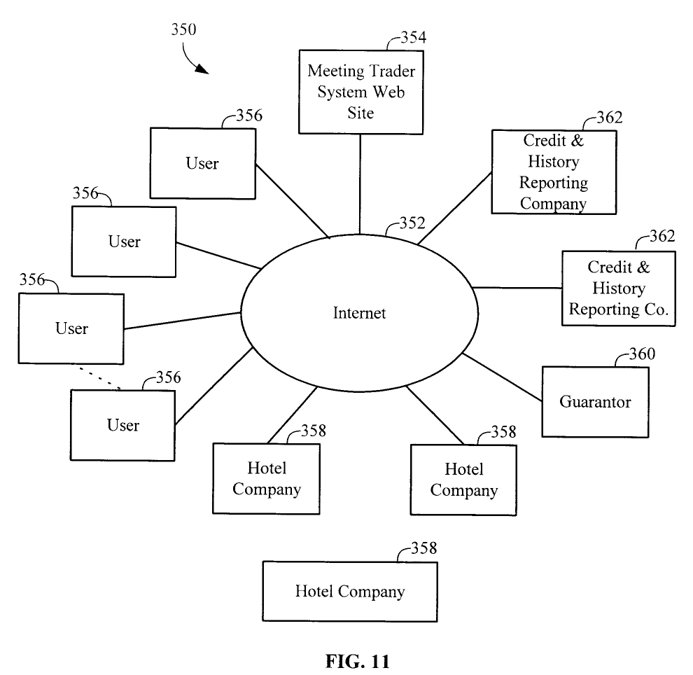

Referring now to FIG. 11 an exemplary system 350 in which communications are provided via the Internet 352 is shown and includes the contract terms system web site 354 which may be formed by one or more web servers storing the software and databases used to operate the system. Multiple users 356 are shown, with their access typically being provided by a personal computer. However, it is recognized that systems in which users access the site 354 using other devices such as Personal Digital Assistants or cell phones could be supported. Hotel company computer systems 358 are shown, along with Guarantor company computer system 360 and credit history company computer systems 362. The system includes a searchable database of group hotel, meeting room and conference center contracts and associated information about the group contracts that are available for transfer associated with the meeting trader web site 354. The database can be a computer, server, or other data storage device capable of storing, receiving and providing data to intended users. The database stores information relating to contracted meetings. Information may include, but is not limited to, contract terms such as contract owner, contract owner's city, state and email; hotel brand name, location, amount and configuration of meeting space available, duration of contract, room rates contracted, deposit terms, financial conditions, room block attrition allowance, contract terms holder, contract term cancellation fee amount, and contract transfer incentive, if any.

Parties interested in selling contracted group hotel, meeting and conference center space may access the website and enter information concerning a contract they wish to sell or transfer in part or in whole. Parties interested in buying contracts may access the website and search the database for contracts, that meet all or some of their selected criteria. In response to requests for contracts the database will generate hits of available group contracts that meet the requested criteria. Once a match is found, the parties may agree to transfer the contract on-line, pay on-line, negotiate terms, seek credit approval or agree to converse off-line and arrange to transfer the contract in a manner acceptable to both parties. Once a transfer is completed, the contract is removed from the database or remains on the database for a predetermined time with an indication that the contract was transferred.

One embodiment of a leasing system and method is described with reference to drawing FIGS. 1-3. In such drawings, each rectangular block (with the exception of blocks 50, 52, 54 and 56) represents a computer generated page, such as a web page, which may be accessible via the Internet. The entries in such “web page blocks” which include associated path lines represent links to other web pages. Entries in such “web page blocks” which do not include associated path lines represent either displayed information or information to be entered or identified by a user as will become apparent through the explanation below.

As shown in FIG. 1, an individual, such as a hotel group meeting contract terms owner, who intends to assign or transfer a contracted meeting first accesses the home page 10 of the Website. At the home page 10, the user is introduced to the Website and is presented with computer generated buttons which activate links which are selectively activated by the individual (e.g. by mouse click) depending on whether the user intends to assume a contracted meeting (“ASSUME CONTRACT”), sell a contracted meeting (“SELL CONTRACT”) or, if the user has already visited the site and registered with the site, sign in and view his or her account (“REGISTERED USER SIGN IN”). If the user is a first-time visitor the user so indicates by clicking on the icon on the home page 10 and is directed to a page 12 which displays the rules, which are basically terms and conditions for using the web site, or gives the individual a link to the rules, which are basically terms and conditions for using the web site, and a link to proceed by confirming that the rules have been read. After reading the rules, which optionally can be displayed or linked to page 14, the contract terms owner is sent to a page or screen 16 at which the contract terms owner creates an account by entering a user identification code (“user ID”) and password.

The contract terms owner then reenters the user ID and password and logs on, as shown in web page block 18 in FIG. 1. Once having logged in, the contract terms owner is directed to a Main Menu page 20 which provides link options which include adding a new contracted meeting record (“ADD CONTRACTED TERMS”), modifying an existing contracted meeting record (“MODIFY CONTRACTED TERMS”), deleting an existing contracted meeting record (“DELETE CONTRACTED TERMS”), listing all of the contract terms entered by that contract terms owner (“LIST ALL TERMS”), or searching for a particular contracted meeting record in a search database (“NEW SEARCH”).

If, for example, the user is a hotel group contract owner who intends to add a contract term, the user is directed to a screen or page 22 at which the user is prompted to enter information pertinent to the contracted meeting and contract terms to be assigned. Such information may include the user's city, state and e-mail; hotel brand name, hotel location, amount and configuration of meeting space available, duration of contract, room rates contracted, deposit terms, financial conditions, room block attrition allowance, contract terms holder, contract terms cancellation fee amount, and contract transfer incentive, if any. Once the information has been entered, the newly created record is displayed as indicated at page block 24. At this point, as indicated at page block 26, the contract terms record is entered into the search database for access by interested users.

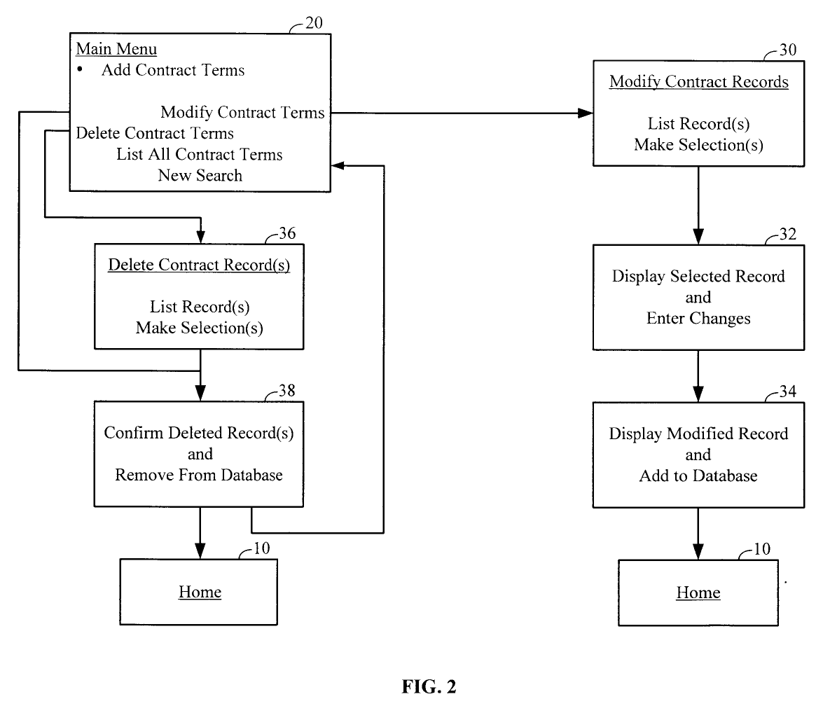

As shown in FIG. 2, if a contract terms owner wishes to modify a contract term, from the Main Menu page 20, the contract terms owner is linked to a “Modify Records” page 30. Screen or page 30 lists all of the contracted meeting records created by that contract terms owner and entered into the database, and prompts the contract terms owner to select a particular contract terms to be modified. The user selects a particular contract terms by mouse-clicking on the appropriate record, and is linked to a screen or page 32 which displays the record to be modified.

At that point, the contract terms owner modifies the data in the field or fields of the record as desired and indicates approval of the modified record by clicking on an appropriate action button. As indicated at page block 34, the modified record is displayed and entered into the database, replacing the original record. The contract terms owner is then sent back to the home page 10.

In the alternative, if the contract terms owner intends to delete a contract terms, that option is selected in the Main Menu page 20 and the contract terms owner is linked to a screen, represented by block 36, which displays all of the contracted meeting records entered by the contract terms owner. The contract terms owner then indicates by a mouse click which contract terms or contract terms are to be deleted, and mouse clicks on an action button to delete the record or records marked for deletion. The contract terms owner is then linked to a screen or page 38 which indicates that the selected contracted meeting records have been deleted from the database. The contract terms owner is then given the option of returning to the home page 10, or in the alternative, adding a contract term, deleting a contract term, modifying a contract term, listing all contract terms, by returning to the Main Menu.

Referring back to FIG. 1, if a user accessing the home page 10 intends to assume (or “buy”) a group contract, the appropriate virtual button (“ASSUME CONTRACT”) is activated and the contract terms buyer is directed to a “Search Database” screen or page 40. It should be noted that the page indicated at block 40 can be accessed from a number of locations at the Website, including the Main Menu page 20.

From the Search Database page 40 the contract terms buyer can select either to view all vehicles in the database, and be linked to “Displaying All Vehicles” at page block 42, or can submit any number of parameters, including, for example the city and state of the hotel; hotel brand name, amount and configuration of meeting space desired, duration of contract, dates desired, and a daily number of rooms desired. Of course, other parameters may be used in the Search Database. Once such information is communicated to the system, which occurs when the contract terms buyer clicks a virtual button labeled “View Available Contracts”, a search of the database is made based upon the entered criteria, and the contract terms buyer is linked to a “Display Selected Contracts” screen or page 44 which displays all of the contracts matching the selected or entered criteria. The website may be configured such that the Display Selected Contracts page 44 displays only those contracts matching all of the selected criteria or those contracts that match at least one or some of the selected criteria.

From the screen or page 42 or 44 the contract terms buyer selects a particular hotel group meeting contract and is instructed to click on the date of the meeting contract, which will pull up a “Display Contract and Hotel Profile” screen or page 46 which displays all of the information pertaining to that contract. The contract terms buyer is then provided with the option of calling up a screen or page 48 which displays the directions pertaining to assuming the contract terms.

At this point, the contract terms buyer has the option of downloading a credit application and meetings information profile, shown at page block 50, filling out the credit application and meeting information and sending it to the contracted hotel, indicated at page block 52. Where a hotel accepts only credit applications and meetings information profiles with original signatures, the transmission of a completed credit application and meeting information profile from a contract terms buyer to a hotel may be performed offline, with the actual contract terms document. However, it is within the scope of this embodiment to provide a system in which a completed credit application and meeting information profile is transmitted electronically to a hotel with appropriate signature verification protocols. The final step with respect to the assignment of the contract terms from the contract terms owner to the contract terms buyer, is to receive the signed credit application and contract terms transfer documentation from the Hotel, shown at block 54.

At any point along this procedure, that is, from blocks 46 through 54, the contract terms buyer may contact the contract terms seller, shown as block 56. At this point, the contract terms buyer can contact the contract terms seller through information displayed on the screen 46, in which the contract terms seller may provide an e-mail address, telephone number, mail address or other contact information. Once the contract terms buyer has contacted the contract terms seller, the parties can negotiate offline (meaning not through use of the subject Website) with respect to the terms of the contract terms assumption. These terms would include the payment, if any, to be exchanged between the contract terms buyer and the contract terms seller to compensate for, by way of example, a security deposit or a cancellation fee or a room block reduction (“ATTRITION”) payment. Of course, it is within the scope of the invention to provide a system in which payment can be made by a contract terms seller to a contract terms buyer in order to make the assumption of the contract terms more attractive.

While it is likely that the contract terms seller will be contacted by a potential contract terms buyer prior to the contract terms buyer downloading a credit application and meeting information profile (block 50), it is within the scope of this embodiment to provide a system in which the contract terms buyer can obtain the credit and meeting profile information first, to verify that the contract terms buyer could qualify to assume the contract terms having a particular financial commitment amount.

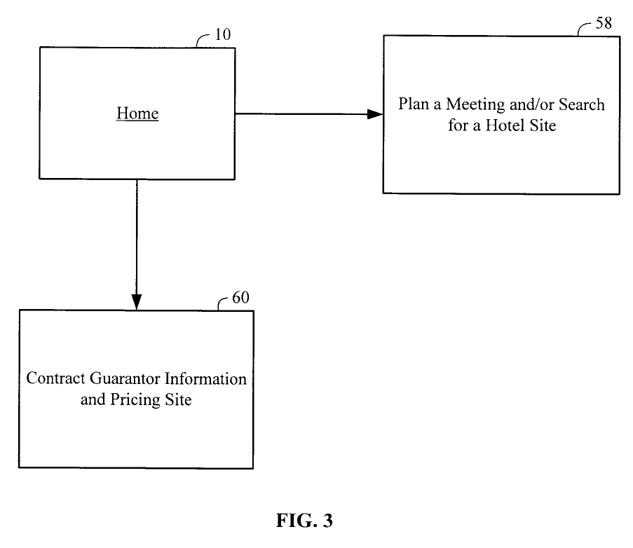

As shown in FIG. 3, the system and method of the present invention provides additional capabilities. For example, from the Home page 10, an individual who decides against assuming a contract, can be linked to a site, represented by page block 58, where hotels are listed for original and direct meeting planner-to-hotel contracting, rather than for contract terms assumption. In addition, an individual at the Home page 10 can be linked to a site, represented by page block 60, at which information pertaining to Guarantor price quotes can be viewed.

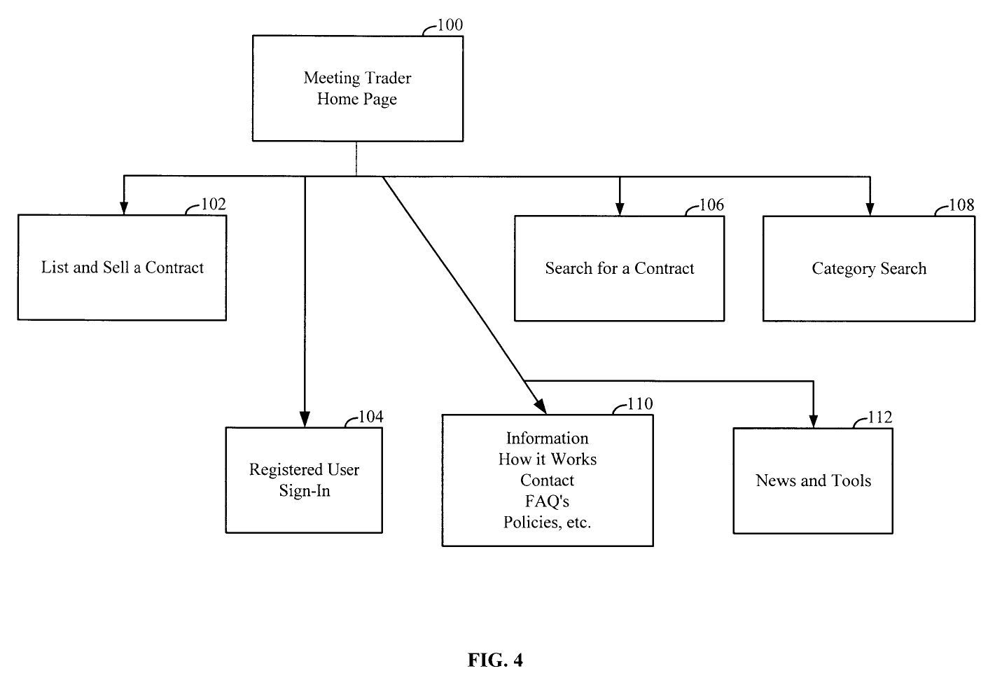

A second embodiment of a method and system for facilitating transfer of hotel meeting contracts between parties is now described with reference to FIGS. 4-9. FIG. 4 depicts the process options available to a user who has entered the Home page 100 of the contract terms system web site Home page 100 provides a user the ability to link to various options of the web site including a sell contract terms link 102, a registered user sign in link 104, a search for meetings contract link 106, a category search link 108, and additional information link 110 and a “News and Tools” link 112. Of course, other links or options could be provided.

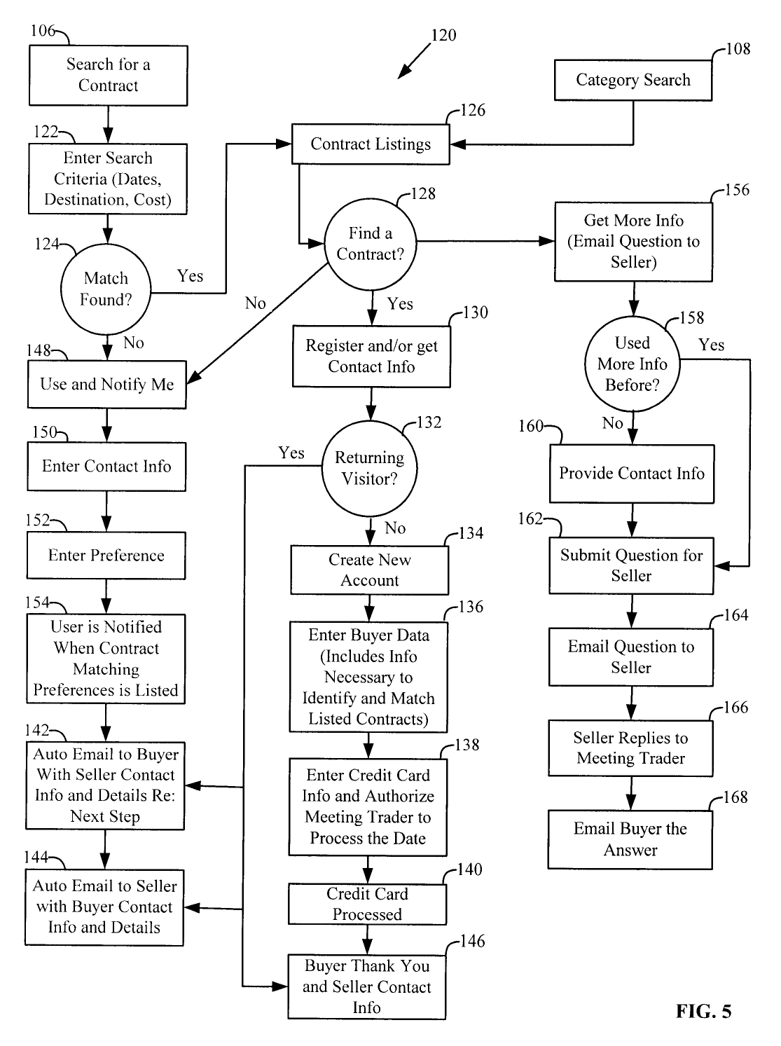

Referring to FIG. 5, a searching user/buyer process 120 is shown. A user selecting the search for a hotel group meeting contract link 106 may be taken to a web page or pages 122 where a user can utilize a search engine to enter certain search parameters for the types and dates of hotels of interest to the searching user. These parameters may, for example, include the city and state of the Hotel or type of meeting location, such as resort, airport hotel, or convention hotel; the dates of the contract assumption sought; the hotel brand name; amount and configuration of meeting space available; room rates contracted; deposit terms, financial conditions, room block attrition allowance, and contract terms cancellation fee amount. Such parameters might be manually entered or could be selected from lists generated on the web page. Of course, other search parameters could be included in a given system. Once the parameters are entered, the search engine conducts a search as indicated at 124 to determine if any hotel group meeting contracts in the contracted meeting records database of the web site meet the criteria entered by the searching user. If so, the searching user may be linked to a web page or pages 126 where the matching contracted meeting records can be viewed. A user who selects the category search link 108 may also be linked to page or pages 126 to view information from contracted meeting records matching the search category. By way of example, possible search categories may include size of contracted hotel, location of contracted hotel, dates of contracted meetings, number of days or nights of contracted meetings and room blocks, room rates of contracted meetings, or total value of contracted meetings.

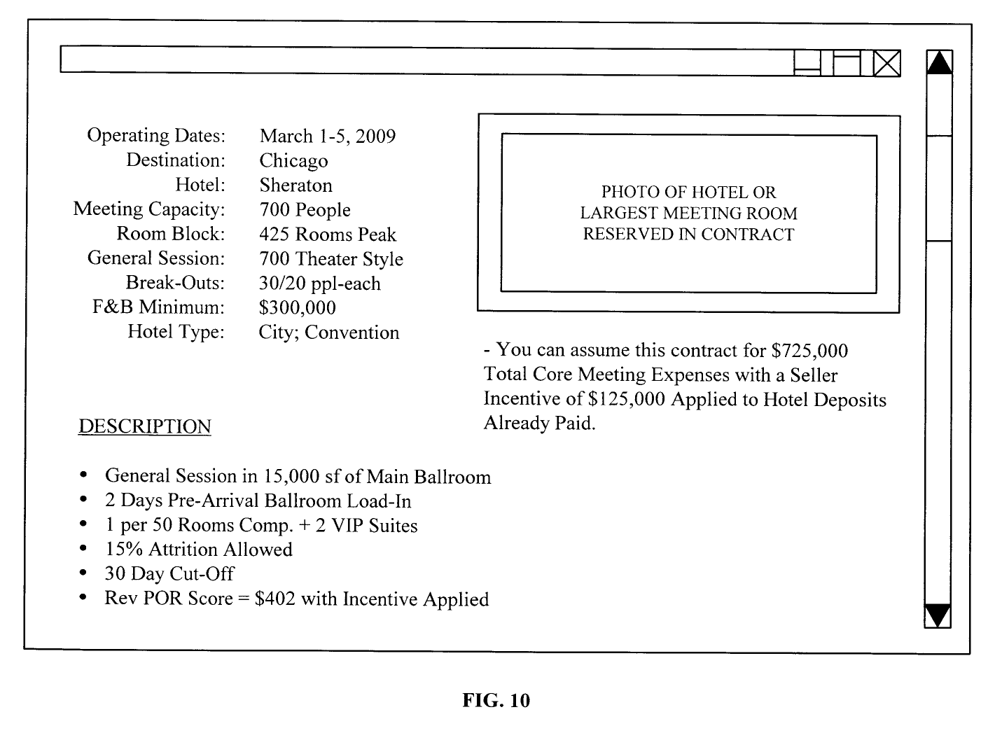

At 126, in one embodiment the contracted meeting records record information may be displayed in a list format, with minimal information being displayed such as the type of hotel, dates of contract, amount and configuration of meeting space available, duration of contract, room rates contracted, deposit terms, financial conditions, room block attrition allowance, contract terms holder, and contracted cancellation fee amount. Each meeting contract in the displayed hotel group meetings contract list may include a link to more detailed information concerning the contract and its associated contracted meeting record. In this manner, the searching user can make a quick determination of whether or not he/she has interest in any of the listed contracts, and if so can retrieve additional information using the link provided on the web page. In this regard, the link associated with each displayed hotel group meeting contract on the list may generate a pop-up window which includes the additional contract and contracted meeting record information. In one embodiment, the information displayed may be in the form shown in FIG. 10 where the information including at least one of hotel brand name, hotel location, dates of contract, amount and configuration of meeting space available, duration of contract, room rates contracted, deposit terms, financial conditions, room block attrition allowance, contract terms holder, and contract terms cancellation fee amount information fields are provided for the searching user. In addition, a meeting contract venue photo may be provided and a summary paragraph defining the contract terms, type of contracted venue, contracted meeting space, contracted group room block, contracted group room rates, contracted Food & Beverage minimum if applicable, and any other pertinent information listed in conjunction with the contracted meeting record may also be provided. The web site software may generate this information automatically. Notably, in this embodiment the searching user is not provided with any listing user information which might enable the searching user to contact the listing user.

If a searching user finds a particular hotel group meeting contract of interest as indicated at 128 in FIG. 5, the searching user may trigger a link to request contact information of the listing user as indicated at 130. At 132, if the searching user is not already a registered user of the site, the searching user is directed to a web page or series of web pages 134, 136, 138 where the searching user can create a new account by entering personal data including, for example, user name information, password information, e-mail information, credit application information, and credit card information. Once the information has been entered, the credit card information may be processed at 140 to charge the searching user a monetary amount to become a registered user of the site. It is contemplated that an automated electronic credit card transaction process may be used. If the credit card transaction clears, the user is added to a registered user data base of the web site and the searching user/buyer is given access to the listing user/seller information for the vehicle of interest at 142. Similarly, the listing user/seller is provided with the searching user/buyer contact information at 144. In one embodiment the listing user and searching user may be provided with such information via automated e-mails. It is also contemplated that the listing user and/or searching user could be provided access to the contact information via a web site page, as indicated at 146. At step 132, if the searching user is already a registered user of the web site steps 134, 136, 138 and 140 may be skipped.

If no matching contracted meeting records record is found at step 124, or if no vehicle of interest is identified in step 128, the searching user may elect to use a notify me option 148 of the search engine in which the searching user enters his contact information 150 (preferably at least e-mail information) which is then stored in a database in association with the listing users entered criteria. The search engine automatically searches the contracted meeting records record data base on a regular basis in the future to determine whether any newly added contracted meeting records meet the entered criteria of the searching user. If so, an automated e-mail to the searching user may be generated informing the searching user that new vehicles of interest are contained in the contracted meeting records database. The e-mail may also include a link to the web page or pages containing information regarding the vehicle or vehicles of interest. After the searching user enters his contact information, the search criteria information may be modified by the user at 152. User notification is illustrated at 154.

Referring again to step 128, for a given meeting contract of interest a searching user may also choose to obtain more information regarding the vehicle as indicated at 156. At step 158, if the searching user has not entered contact information previously, the information is entered on the web site at 160. Otherwise, at 162 the searching user/buyer enters a question or otherwise requests additional information from the listing user/seller. The information may be entered via a web page entry screen, and then automatically e-mailed on to the listing user/seller at 164, without identifying the searching user to the listing user. The listing user/seller replies to the e-mail at 166 and the reply is automatically forwarded to the searching user/buyer at 168, without identifying the listing user to the searching user.

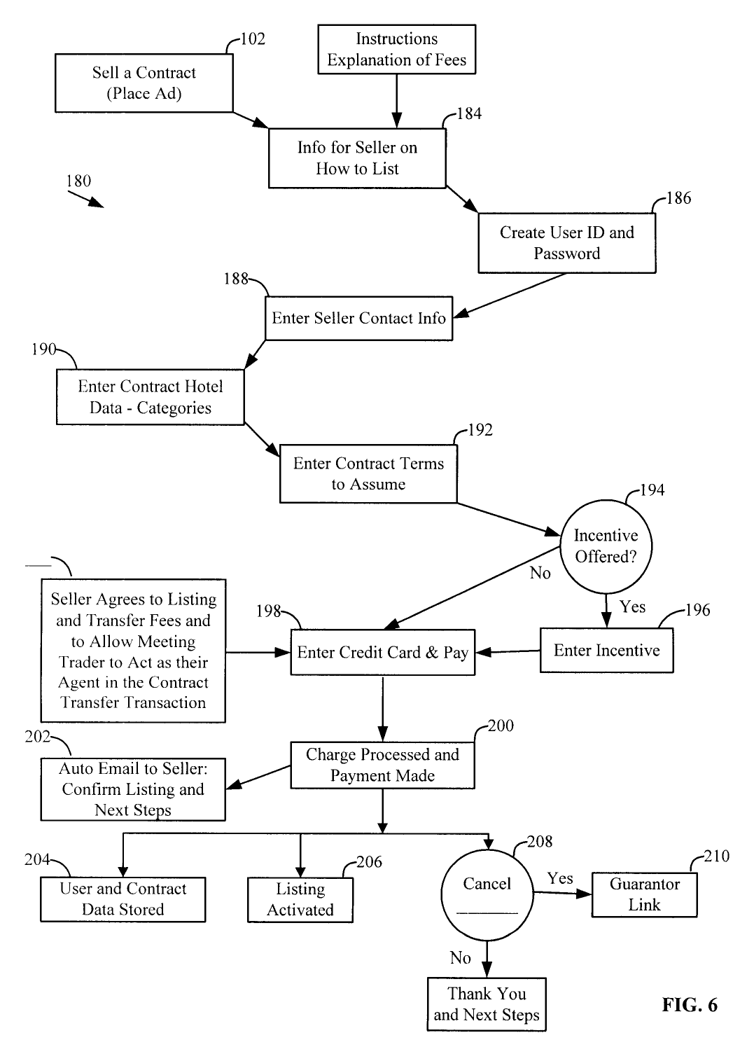

A listing user/seller add placement process 180 is now described with reference to FIG. 6. From the Home page 100, the listing user selects the sell a contract terms link 102 and is taken through a series of web pages and/or pop up windows which allow the user to enter appropriate information as needed. As indicated at 184, the listing user may first be provided with information about how the hotel group meeting contract listing process works. At 186, the listing user either logs in (assuming the listing user is already a registered user and has created an account with the website) or the listing user creates a new account. At this step a previously registered listing user simply enters login information such as a login name and password and is then directed to a screen or page where the listing user can verify the continued accuracy of the listing user's account information. An unregistered listing user may be directed to a series of pages or screens for the entry of required account information including a desired user name and password, legal name, date of birth, social security number, residence address, telephone number, and e-mail address. Once the listing user has either logged in and verified account information or entered new account information at 188, the listing user may be taken through a series of web-pages or screens 190 which enable the listing user to enter data about the particular meeting contract which the listing user intends to list on the website. In one embodiment the listing user may enter the information manually, or in another embodiment the listing user may use an input device such as a mouse to select from options displayed on the web pages. The information typically entered might include an incentive amount, hotel brand name, hotel location, dates of contract, amount and configuration of meeting space available, duration of contract, room rates contracted, deposit terms, financial conditions, room block attrition allowance, contract terms holder, contract terms cancellation fee amount, and additional information or comments the listing user wishes to provide. The listing user may also be provided the ability to upload an image of the contracted meeting venue as part of the contract listing record, or the listing user may select from a number of stock venue images stored in a database on the web site. Alternatively, listing users may be given the option of mailing a contracted meeting venue photograph to the website administrator.

Once the vehicle information is entered at 190, the listing user may then be directed to a web page or series of web pages/screens in order to enter contracted meeting records information as indicated at 192. The information entered by the listing user may include the contracted hotel brand name, hotel location, dates of contract, amount and configuration of meeting space available, duration of contract, room rates contracted, deposit terms, financial conditions, room block attrition allowance, contract terms holder, and contract terms cancellation fee amount. After the contracted meeting records information has been entered at step 192, the listing user may be given the option of providing an incentive as indicated at step 194. If the listing user chooses to provide an incentive, the listing user may be directed to a page or screen where the incentive may be entered as indicated at 196. After entry of the incentive, or if no incentive is to be offered, the listing user enters credit card information at step 198 to pay a required monetary fee in order to have the hotel group meeting contract information listed on the website. At such time the listing user agrees to all listing and transfer fees and also agrees that the website administrator will act as their agent in the contract terms transfer transaction. At step 200 the electronic credit card transaction is processed and, if approved, an automated e-mail is sent to the listing user/seller to confirm that the vehicle has been listed and to provide details on what may happen next as indicated at step 202. At 204 the contracted meeting record is added to the website database and the listing is activated at 206. Upon successful completion of the electronic credit card transaction the listing user may also be queried as to whether or not the listing user will continue to be held liable to the contracted hotel even after transfer of the contracted meeting records to another party. This query is shown at 208 and may be in the form of a simple question presented to the listing user. Alternatively, because hotel companies do not use standardized agreements, the website may collect and store information regarding continued contractual liability of the listing user after transfer and may automatically determine whether or not the listing user will continue to be held liable. If the listing user will continue to be held liable the listing user may be directed to a Guarantor link 210 where a Guarantor may be obtained to cover the continued liability as will be explained in further detail below.

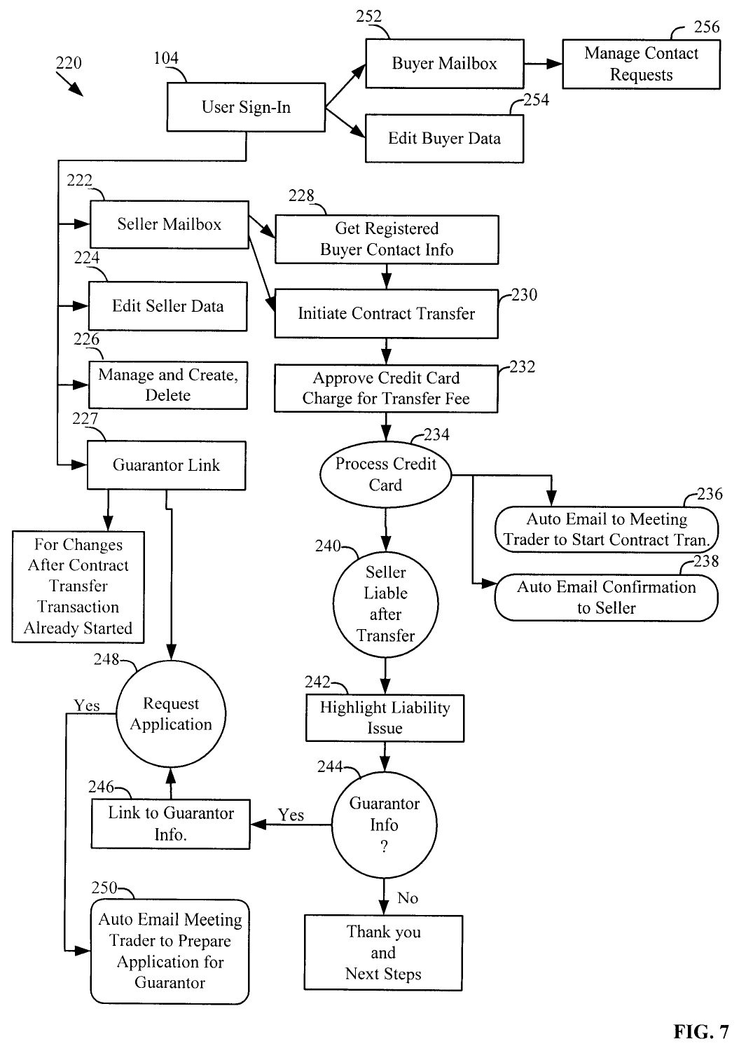

The hotel group meeting contract terms transfer system website may also be set up to allow listing users/sellers and/or searching users/buyers to manage their accounts as will be explained with reference to the process chart 220 of FIG. 7. From the registered users sign in link 104 of the home page a listing user may be provided with options including seller mail box option 222, edit seller data option 224, manage add option 226, and Guarantor link option 210. Via the seller mail box option 222, the listing user may view registered searching user/buyer contact information for any searching user who has indicated an interest in a given vehicle listed by the listing user as indicated at 228. The listing user may also initiate a transfer of a contract terms for a given meeting contract listed by the listing user as indicated at 230. The listing user may be charged a monetary fee via electronic credit card transaction as indicated at 232, 234 in order to initiate the contract terms transfer. If the credit card transaction is approved an electronic message 236 triggers the website administrator to initiate the contract terms transfer and an electronic message 238 to the listing user to confirm that the contract terms transfer process has been initiated. With regard to electronic message 236, where the contract terms transfer process is wholly automated this electronic message may simply trigger website software to perform the contract terms transfer process as will be explained below. Alternatively, where one or more of the contract terms transfer process steps is conducted manually, this electronic message may be an e-mail to the website administrator.

After the electronic credit card transaction is approved at step 234, a determination may be made at step 240 as to whether or not the listing user will remain liable to contracted hotel after transfer of the contracted meeting terms. This determination may be made as previously described. If so, at step 242 an explanation of the liability issue may be provided to the listing user. If the listing user expresses an interest in a Guarantor to cover the continued liability at step 244, the listing user may be directed to a page 246 which explains in detail the coverage available to the listing user through the system. If the listing user chooses to request a Guarantor at step 248, an electronic message 250 may be generated to initiate the Guarantor application process. The electronic message 250 may initiate an automated preparation of an application which can be electronically forwarded to the Guarantor for approval, with such approval notification being electronically transmitted back to the website and forwarded on to the listing user. Alternatively, where paper documentation is required the Guarantor application may be generated and forwarded to the listing user for signature, with the application then being forwarded onto the Guarantor.

The edit seller data option 224 enables the seller to edit his account information, such as telephone number, address, e-mail address, etc. The manage add option 226 enables the listing user, via contract terms action engine software, to create new hotel group meeting contract records, edit existing contracted meeting records, delete existing contracted meeting records, and/or extend the active time period of a given contracted meeting record. In this regard, when a listing user creates a new contracted meeting records record it is stored in the contracted meeting records database in association with information identifying the listing user. Using option 226 the listing user only has access to edit, delete or to extend vehicle contracted meeting records which are associated with the particular listing user (as by login information and name). The extend capability for a given contracted meeting record is based upon an embodiment in which the listing user pays a first monetary amount to have a vehicle listed for a set period of time (such as two weeks), and after that set time the vehicle listing is automatically deactivated. If the listing user has not sold/transferred the contracted meeting terms by that time, the listing user may select the extend option and pay an additional monetary amount to keep the contracted meeting listing active on the site for an additional time period.

Liability insurance link 227 enables the listing user to request Guarantor coverage after the contract terms transfer has been initiated. For example, where a listing user originally elects not to obtain the Guarantor, and then has a change of heart, the listing user can reenter the system and use link 227 to obtain the Guarantor coverage.

After sign in, a searching user/buyer maybe given various options including a buyer mailbox option 252 and in edit buyer data option 254. Using the buyer mailbox option 252, the searching user may manage the searching users previous contact requests as indicated at 256. For example, the searching user may elect to withdraw a previously indicated interest in a particular meeting contract search. Using the edit data option 254 the searching user may change the contact information stored on the system, such as address, telephone number, e-mail, etc.

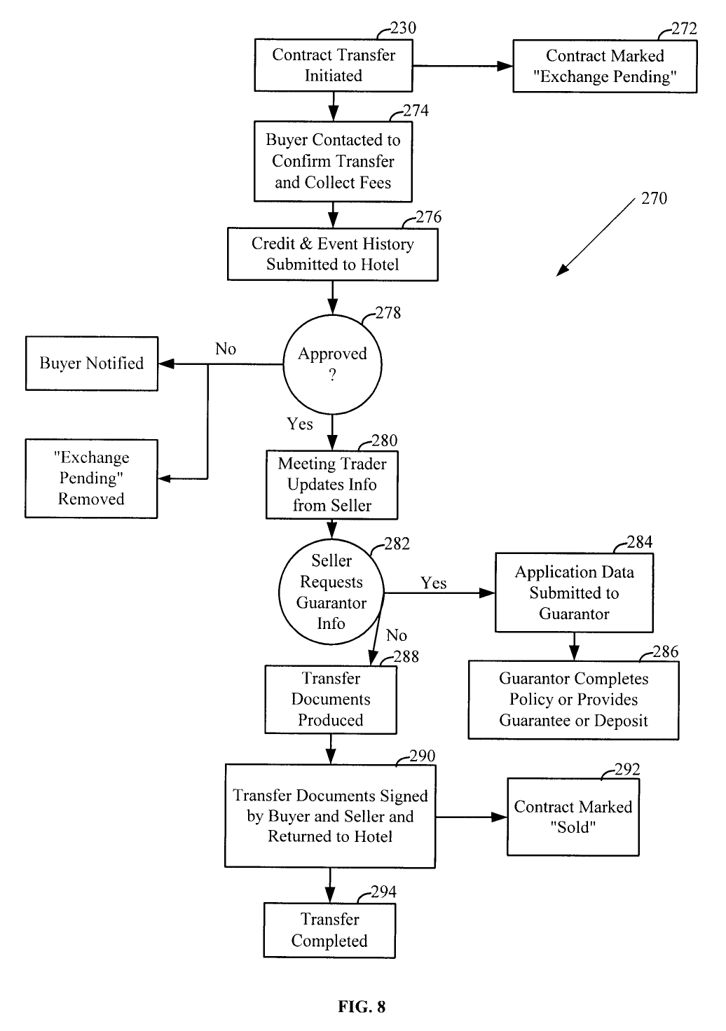

A contract terms transfer process diagram 270 is shown in FIG. 8. When a listing user initiates a contract terms transfer at 230, the contracted meeting record is marked as a “trade pending” record in the contracted meeting records database at 272. In this manner future searching users viewing information concerning the vehicle associated with the contracted meeting record will be informed that a contract terms transfer has already been initiated for the listed hotel group meeting contract. At step 274 the searching user/buyer is contacted to confirm that it is okay to proceed with the contract terms transfer. Such contact may be made in an automated electronic manner, such as via e-mail, with the searching user approving the contract terms transfer by return e-mail or by accessing the website. Various contract terms transfer fees may also be collected from the searching user/buyer at this time, including any hotel related credit application fees, which may be collected via electronic credit card transaction. At step 276 a credit application and meeting information profile is prepared for the searching user/buyer and is submitted to contracted hotel venue. The credit application and meeting information profile may be generated automatically in electronic format based upon the information that the searching user previously entered in creating the listing user site account, and may be electronically transmitted to the contracted hotel venue. It is also possible that the credit application and meeting information profile may be printed in hard format and submitted in such format to the contracted hotel venue. If the credit application and meeting information profile is approved by the contracted hotel venue at step 278, as may be indicated by an electronically generated message by the contracted hotel venue, the website contacts the listing user/seller at 282 to update necessary information for the contract terms transfer, primarily the customization of contracted dates, meeting space, and room block to the buying user. Such contact may be made via telephone, fax, or by an automated e-mail to the listing user which directs the listing user to access the website and enter the required update information.

If the listing user has requested a Guarantor as determined at step 282 the application can be submitted to the Guarantor company at 284 and the Guarantor company can generate and complete the contract at 286. In one embodiment such application submission and policy generation may be a fully automated electronic process. At step 288 the necessary contract terms transfer documents are produced using the information which has been previously provided by both the listing user/seller and the searching user/buyer. Such document preparation may be an automated electronic process or may involve some human intervention. The transfer documents are forwarded to the searching user/buyer and the listing user/seller for review and execution and are then returned to the leasing company at step 290. Where the documents are electronically generated they may be electronically forward to the users, via e-mail or via the website, with the users providing electronic approval/signature to the documents. Alternatively hard copies of the documents may be forwarded to the users for manual signature. Similarly, the executed documents may be forwarded electronically to the contracted hotel venue, or hard copies of the documents may be forwarded. At step 292 the hotel group meeting contract is marked “SOLD” in the contracted meeting records database so that future searching users will not unnecessarily waste their time by expressing interest in a hotel group meeting contract which is no longer available. At step 294 the transfer is shown as completed.

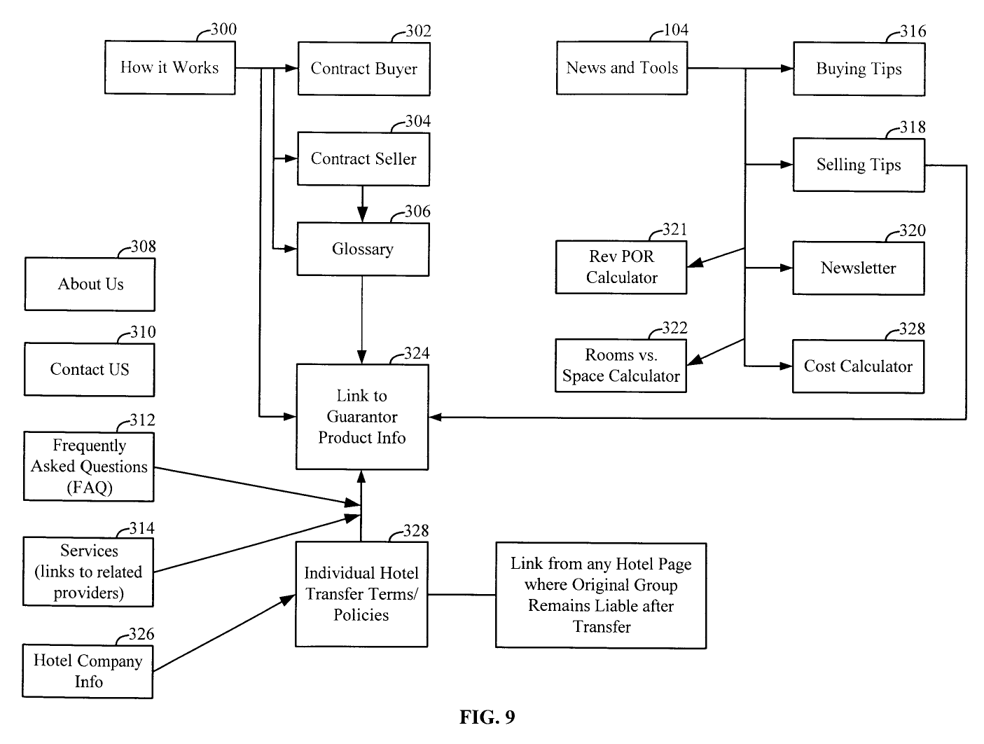

As shown in FIG. 9, the additional information link 110 of the website homepage 100 may provide the users with various information concerning how the process works, as well as links to other information which may be helpful to the users. For example, a “How it Works” link 300 may provide an explanation of the process which is directed to searching user/buyers as indicated at 302 and may also provide an explanation which is directed to listing users/sellers as indicated at 304. A glossary of various terms may be provided at 306. The link 308 would direct the users to an explanation of the company running the website while link 310 would provide contact information for the website operator. A link to frequently asked questions (and answers to the same) may be provided at 312, and a link which would direct users to related service providers may be provided at 314. The “News and Tools” link 112 may be used to direct users to buying tips 316, selling tips 318, a site newsletter 320, a Revenue Per Occupied Room (“RevPOR”) calculator 321, a Rooms vs. Space Ratio Calculator 322 to measure the desirability of transferable physical elements detailed in a contract, and a Contract Valuation Calculator 323. From various locations in this process the users may be directed by link 324 to the Guarantor product information. Links to particular hotel companies may also be provided as shown at 326 in order to provide both listing users and searching users with information about the particular contracted hotel venue associated with a given contracted meeting record at 328.

It is understood that the preceding description is merely a detailed description of some examples and embodiments and methods of use of the present invention and it is recognized that various changes and modifications could be made without departing from the spirit and scope of the invention. The preceding description, therefore, is not meant to limit the scope of the invention but to provide sufficient disclosure to one of ordinary skill in the art to practice the invention without undue burden.

What is claimed is:

1. A computer implemented method for facilitating the transfer of meeting contracts between parties comprising:
(a) providing a database of available contracted meetings for transfer;
(b) retrieving a selection of one or more available contracted meetings based on a requestor's selected parameters;
(c) displaying said selection of one or more available contracted meetings; and
(d) choosing one of said selection of one or more available contracted meetings for transfer.

2. The method of claim 1 further comprising transferring the chosen one of said available contracted meetings from a contract terms owner to a contract terms buyer.

3. The method of claim 2 wherein said step of transferring includes transferring all of the terms of said chosen one of said selection of one ore more available contracted meetings to a contract terms buyer.

4. The method of claim 1 wherein the step of providing a database of contracted meetings includes providing a means for modifying the database of contracted meetings.

5. The method of claim 1 wherein said method of providing a database of contracted meetings includes providing at least one of the following terms for each of said contracted meetings: incentive amount, allowed reservation terms, contracted terms for room rates, contract terms meeting space and applicable fees, contract terms holder, contract terms early termination (“cancellation”) buyout amount, payments remaining on contract terms, hotel brand name, location, amount and configuration of meeting rooms, duration of contract and date of contract.

6. The method of claim 1 further including the step of registering at least one of said parties as a verified user.

7. The method of claim 1 further including the step of verifying the credit worthiness of at least one of said parties.

8. The method of claim 2 further including enabling said contract terms owner to electronically obtain a guarantor for coverage of contractual liability retained by the contract terms owner even after transfer of the contracted meeting to a contract term buyer.

9. A method for facilitating the transfer of meeting contracts between a contract terms owner and a contract terms buyer comprising
(a) providing a searchable data storage device capable of storing information related to meeting contracts;
(b) inputting meeting contract terms into said searchable data storage device;
(c) selecting meeting contracts in response to requests to view said stored meeting contracts based on meeting contract terms; and
(d) displaying said selected meeting contracts.

10. The method of claim 9 further comprising transferring at least one of said selected meeting contracts to a contract terms buyer.

11. The method of claim 10 wherein said step of transferring includes transferring ownership of all of the terms of at least one of said selected meeting contracts to a contract terms buyer.

12. The method of claim 9 wherein the step of inputting includes modifying the database of contracted meetings in said searchable data storage device.

13. The method of claim 11 wherein said method of inputting making contract terms includes providing at least one of the following terms for each of said meeting contracts: incentive amount, allowed reservation terms, contracted terms for room rates, contract terms meeting space and applicable fees, contract terms holder, contract terms early termination (“cancellation”) buyout amount, payments remaining on contract terms, hotel brand name, location, amount and configuration of meeting rooms, duration of contract and date of contract.

14. The method of claim 9 further including the step of registering at least one of said contract terms owner and a contract terms buyer as a verified user.

15. The method of claim 9 further including the step of qualifying at least one of said contract terms owner and said contract terms buyer as creditworthy.

16. The method of claim 9 further including enabling said contract terms owner to electronically obtain a guarantor for coverage of contractual liability retained by the contract terms owner even after transfer of the contracted meeting to a contract term buyer.

17. The method of claim 9 further including requiring said contract terms buyer to pay a fee in order to view some or all of the terms associated with said selected meeting contracts.

18. The method of claim 9 further including requiring said contract terms owner pay a fee in order to input terms of said meeting contracts into said searchable data storage device.

19. A network system providing a marketplace for transferring contracted meeting services between parties comprising:
(a) a first computer having a data storage device
(b) available meeting contracts having contracted meeting terms stored on said first computer;
(c) means for inputting meeting contracts having contracted meeting terms into said data storage device;
(d) a second computer having the ability to access said data storage device of said first computer;
(e) a search engine, capable of searching for available meeting contracts stored in said data storage device of said first computer having selected contracted meeting terms;
(f) a display associated with said second computer for displaying meeting contracts having selected contracted meeting terms;
(g) means for transferring at least one of said meeting contracts having selected contracted meeting terms to a contract terms buyer.

20. The invention of claim 19 wherein said first computer is a web server.

21. The invention of claim 19 including a notification means for notifying said second computer when a hit occurs with respect to meeting contracts having selected contracted meeting terms.

22. The network system of claim 19 wherein said means for inputting includes means for modifying contracted meeting terms associated with meeting contracts stored on said first computer.

23. The network system of claim 19 wherein said second computer is a cell phone a PDA.

24. The network system of claim 19 further including links to credit card notification systems.

25. The network system of claim 19 further including links to related web sites.
